(19) United States
(12) Patent Application Publication
(10) Pub. No.: US 2001/0036129 A1
(43) Pub. Date: Nov. 1, 2001

(54) Timing device to warn refrigerated product expiration

(76) Inventor: Raymond Alan Carr, Lutz, FL (US)

Correspondence Address: Raymond A. Carr, 1872 Daiquiri Lane, Lutz, FL, 33549, US

(21) Appl. No.: 09/809,674

(22) Filed: Mar. 15, 2001

Related U.S. Application Data
(60) Provisional application No. 60/189,579, filed on Mar. 15, 2000.

(51) Int. Cl. G04F 8/00; G04F 10/00

(52) U.S. Cl. 368/109

(57) ABSTRACT

An expiration timer device designed to provide information regarding the passage of time with respect to foodstuffs within an attached container. The device is a timing and display system which, when activated, monitors the passage of time and presents this information to the user to enhance their ability to determine the quality of foodstuffs within the container.

### BACKGROUND OF THE INVENTION

The present invention relates to a device that indicates the time that has elapsed from a starting time/date and provides an alarm means which indicates the product shelf life has declined to within a given time of some preset expiration time/date. The alarm means may be gated by the presence of light, such as that provided when a refrigerator is opened.

Certain products require refrigeration immediately after purchase, or opening, and it is often the case that these products are stored in a household refrigerator. As time progresses, it is possible that these products are either pushed to the back of the refrigerator, or completely forgotten about. When the product is eventually identified for use, often the amount of time that has elapsed between its initial insertion and subsequent removal is unknown. In many cases the user may discard the product entirely due to fear of spoilage.

To combat this issue, many people write/place dates on frozen and refrigerated foodstuffs. Certainly this helps determine the elapsed time since the product was initially opened or refrigerated, but this does nothing to aid in the identification of products which are reaching their expiration unless they are specifically singled out and reviewed frequently prior to expiration.

### BRIEF SUMMARY OF THE INVENTION

It is the object of this invention to provide a device that indicates the time that has elapsed from a starting time/date as well as provide an alarm means which indicates the product shelf life has declined to within a given time of some preset expiration time/date. The alarm means may be gated by the presence of light, such as that provided when a refrigerator is opened.

During operation of the device, the user utilizes the panel keys to input the amount of time that the product may be used and/or stored in the refrigerator. The device is then reset to initialize the timing of the product and the product placed in the refrigerator for storage.

Subsequently, when the device senses that the refrigerator door has been opened, it indicates the status of the product with respect to the time left until expiration. At some percentage of elapsed time versus total time for expiration, an expiring alarm indicator will be activated to alert the user as to the limited shelf life of the product. When the total time that has elapsed exceeds the programmed time until expiration, an expired alarm indicator will be activated to alert the user as to the expiration of the product.

### BRIEF DESCRIPTION OF THE SEVERAL VIEWS OF THE DRAWING

FIG. 1 is a block diagram of the control system in communication with relevant input and output devices;

FIG. 2 is a frontal view of the proposed invention utilizing a strap for connection to a refrigerated foodstuffs container;

FIG. 3 is a frontal view of the proposed invention utilizing adhesive tape for connection to a refrigerated foodstuffs container.

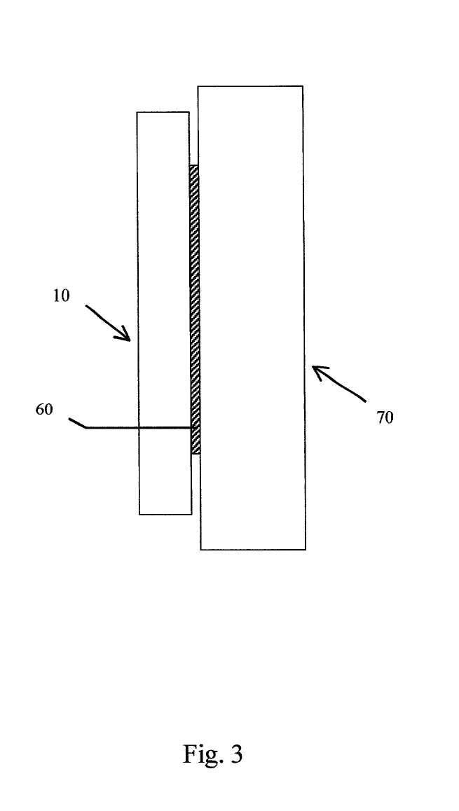

### DETAILED DESCRIPTION OF THE INVENTION

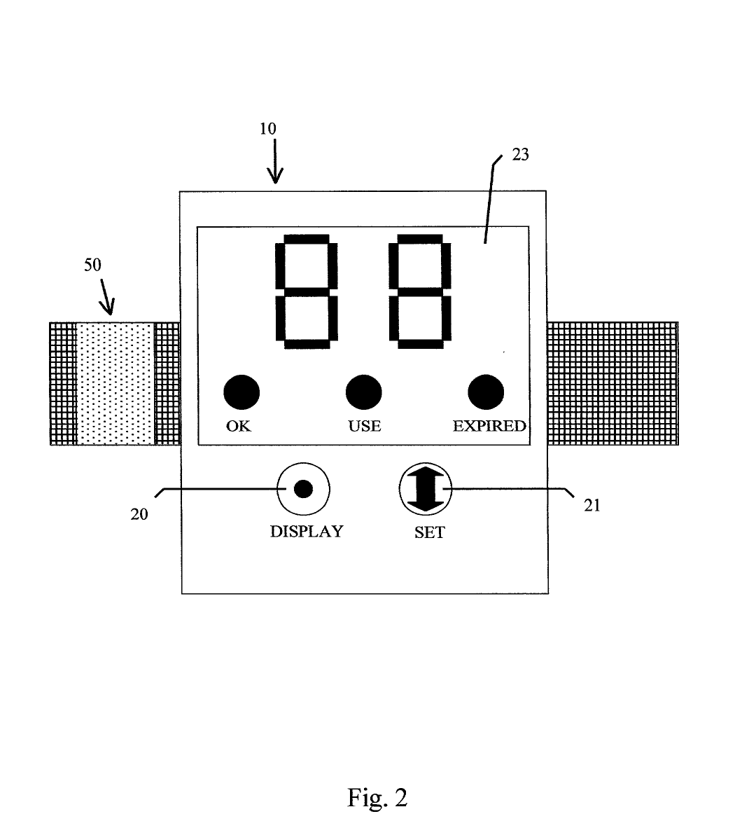

Referring to the drawings, FIG. 2 illustrates an expiration timer (10) that alerts the user as to the time status of the foodstuffs within a container to which the expiration timer (10) is attached via the associated strap (50). The expiration timer displays the time remaining until expiration on the visual display (23) as well as the time remaining if selected by the display mode switch (20).

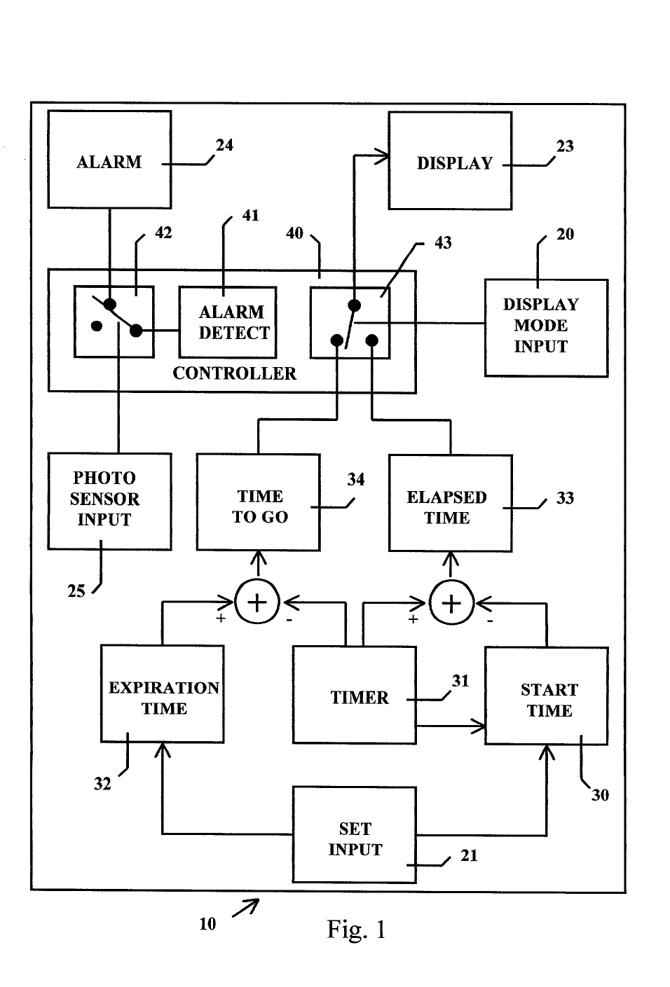

During installation, the user would retrieve a container of perishable foodstuffs and attach the expiration timer (10) to it utilizing either a strap (50) method, or an adhesive (60) method. Once the expiration timer has been attached, the user will set the number of days that may pass before the product is deemed to be inedible. FIG. 1 illustrates that setting this time span takes place by pressing the set input (21) until the desired number of days shows on the display (23) and this expiration time-stamp is stored in its associated (32) block. At this point the expiration timer (10) is operable and may be placed in the refrigerator to monitor elapsed time. It is also at this point that the start time block (30) retrieves a start time time-stamp from the timer (31).

During operation, the elapsed time is calculated by subtracting the start time time-stamp in the start time block (30) from the present time in the timer (31) and the result is stored in the elapsed time (33) block. As well, the time to expiration is calculated by subtracting the present time in the timer (31) from the expiration time-stamp and the result is stored in the time-to-go block (34). After the calculations have been completed, the controller (40) checks to see if the result in the time-to-go block (34) is below a pre-set minimum limit, i.e. 2 days, and if so the visual display (23) will indicate that the product will expire in the near future. If the result in the time-to-go block (34) is less than or equal to zero an expired status is displayed on the visual display (23). At any time, the user may remove the foodstuffs container with the attached expiration timer (10) from the refrigerator and view the resultant times via the display (23). If no input is detected on the display mode input device (20) then the controller (40) directs the visual display (23) to display the time in the time-to-go block (34). Otherwise, if input is detected on the display mode input (20), the controller (40) directs the visual display (23) to display the time in the elapsed time block (33).

An alarm (24) may be present on the expiration timer (10) to enhance its ability to signal status to the user. This alarm (24) would be activated if the controller (40) determines that the foodstuffs have expired or will expire in the near future. To minimize the possible annoyance of a continuous alarm (24), a photo-sensor (25) may be implemented which the controller (40) evaluates to ensure that the alarm (24) is only active while the refrigerator door is opened, i.e. light present.

To minimize power usage the controller (40) may use the output from the photo-sensor (25) to trigger entry into a low-power sleep mode when the refrigerator door is closed. In this low power mode, the controller (40) turns off all system resources except the timer (31). The controller (40) may periodically wake up from the sleep-mode to check the photo-sensor (25) output. If the controller (40) detects the presence of light via the photo-sensor (25), then it will wake-up all system resources and continue with normal operation.

It will now be evident to those skilled in the art that there has been described herein a timing device to warn of refrigerated product expiration that provides valuable information to a user as to the state of the foodstuffs within an attached container.

Although the invention hereof has been described by way of example of preferred embodiments, it will be evident that other adaptations and modifications can be employed without departing from the spirit and scope thereof.

The terms and expressions employed herein have been used as terms of description and not of limitation; and thus, there is no intent of excluding equivalents, but on the contrary it is intended to cover any and all equivalents that may be employed without departing from the spirit and scope of the invention.

What I claim as my invention is:

1. A timing device to warn of refrigerated product expiration comprising:
(a) timing means;
(b) pre-determined point in time input means capable of establishing a pre-determined point in time;
(c) visual display means;
(d) time period means capable of determining the time period between the present point in time and said pre-determined point in time utilizing said timing means;
(e) visual display control means to control said visual display;
(f) wherein said visual display control means further comprise means to display data provided by said time period means;
(g) housing means capable of containing said timing means, said pre-determined point in time input means, said time period means, said visual display means, and said visual display control means;
(h) means to affix said housing means to a refrigerated foodstuffs container.

2. The timing device to warn of refrigerated product expiration of claim 1, further including:
(a) alarm means;
(b) alarm control means to control said alarm means;
(c) wherein said alarm control means further comprise means to utilize time period data from said time period means, said alarm control means activating said alarm means when said time period data from said time period means is determined to exceed pre-determined alarm boundaries.

3. The timing device to warn of refrigerated product expiration of claim 1, further including:
(a) visual display mode input means;
(b) second pre-determined point of time means capable of establishing a second pre-determined point in time when said pre-determined point in time input means was activated;
(c) second time period means capable of determining the time period between said present point in time and said second pre-determined point in time utilizing said timing means;
(d) wherein said visual display control means further comprise means to display second time period data provided by said second time period means, said visual display control means utilizing input from said visual display mode input means to determine the display dataset.

4. The timing device to warn of refrigerated product expiration of claim 2, further including:
(a) photo-sensing input means responsive to ambient light level;
(b) wherein said alarm control means further comprise means to enable and disable said alarm means utilizing data from said photo-sensing means.
